(19) United States
(12) Patent Application Publication
(10) Pub. No.: US 2013/0044775 A1
(43) Pub. Date: Feb. 21, 2013

(54) THERMAL CONDUCTION PATH FOR A HEAT-SENSITIVE COMPONENT

(71) Applicants: Bruce A. BORCHERS, Scotts Valley, CA (US); Phillip H. Malyak, Canton, MA (US); John M. Watson, Haverhill, MA (US)

(72) Inventors: Bruce A. BORCHERS, Scotts Valley, CA (US); Phillip H. Malyak, Canton, MA (US); John M. Watson, Haverhill, MA (US)

(21) Appl. No.: 13/210,838

(22) Filed: Aug. 16, 2011

(51) Int. Cl. H01S 3/04; B23K 1/20

(52) U.S. Cl. 372/34; 228/249

(57) ABSTRACT

A thermal conduction path for a heat-sensitive, heat-generating component is formed by placing a heat-generating device, such as a laser diode, in a desired orientation relative to a supporting surface. A solid-phase mass of a heat-conducting material is positioned between the heat-generating device and the supporting surface and is converted to liquid phase by heating the supporting surface. Additional heat-conducting material is then added to the liquid-phase heat-conducting material until a meniscus is formed between the heat-generating component and the supporting surface. Because the heat-conducting material has a melting point or liquidus that is less than a critical temperature of the heat-generating component, the thermal conduction path can be formed without damaging the heat-generating component.

### BACKGROUND OF THE INVENTION

1. Field of the Invention

Embodiments of the present invention relate generally to heat-sensitive devices and, more specifically, to a thermal conduction path in an assembly that includes a heat-sensitive component and a method of forming the same.

2. Description of the Related Art

In many devices, precision placement and orientation of certain components is important for proper operation of the device. For example, laser-based systems and other optical assemblies can be so sensitive to the physical alignment of certain components that even the small changes in geometry resulting from thermal expansion and/or contraction of the components can degrade the performance of such systems. Consequently, when temperature-sensitive systems include one or more heat-generating components, such as power supplies or laser diodes, a robust thermal conduction path provided for the heat-generating component can minimize thermal expansion and contraction effects and improve the performance, reliability, and operating temperature range of the temperature-sensitive system.

Air gaps adjacent to a heat-generating component provide a poor thermal conduction path, so that the heat-generating component may undergo undesirable temperature changes when in operation. Metallic solders can be used to fill air gaps or otherwise form a thermal conduction path for heat-generating components in a temperature-sensitive system, but the melting-point temperature of solders is typically high enough to damage many components found in such systems, such as electronics, optics, laser diodes, precision plastic parts, and the like. In lieu of such solders, thermally conductive pastes known in the art can be used to fill narrow air gaps and provide a better thermal conduction path than an unfilled air gap adjacent to a heat-generating component. A serious drawback of thermally conductive pastes is that they generally have a very low coefficient of thermal conductivity, e.g., approximately an order of magnitude less than that of metallic solders. When the heat load to be removed by and/or an air gap to be filled with such conductive pastes is relatively large, the low coefficient of thermal conductivity inherent in such pastes cannot provide an adequate thermal conduction path for the heat-generating component. As the foregoing illustrates, there is a need in the art for a thermal conduction path for a temperature-sensitive component that will not damage the temperature-sensitive component when being formed.

### SUMMARY OF THE INVENTION

One embodiment of the present invention sets forth a thermal conduction path for a heat-sensitive, heat-generating component and a method for forming the same. In the method, the thermal conduction path is formed by placing a heat-generating device, such as a laser diode, in a desired orientation relative to a supporting surface. A solid-phase mass of a heat-conducting material is positioned between the heat-generating device and the supporting surface and is converted to liquid phase by heating the supporting surface. Additional heat-conducting material is added to the liquid-phase heat-conducting material until a meniscus is formed between the heat-generating component and the supporting surface. Because the heat-conducting material has a melting point or liquidus that is less than a critical temperature of the heat-generating component, the thermal conduction path can be formed without damaging the heat-generating component.

One advantage of the present invention includes a highly conductive thermal path for a temperature-sensitive device that can be formed without altering the alignment, positioning, and orientation of the device. In addition, embodiments of the present invention advantageously provide a method for forming such a conductive thermal path that will not damage the temperature-sensitive device.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic view of a laser diode array that may benefit from embodiments of the invention;

FIG. 2 is a schematic illustration of one laser diode assembly of a laser diode array mounted on a baseplate and thermally coupled to the baseplate via a thermal conduction path, according to an embodiment of the invention;

FIG. 3 illustrates an embodiment of the invention in which positioning members are fixed to a baseplate prior to positioning a laser diode assembly.

FIGS. 4A-G illustrate schematic side views of a thermal conduction path being formed between a laser diode and a baseplate, in accordance with one embodiment of the invention; and

FIG. 5 sets forth a flowchart of method steps for forming a thermal conduction path, according to embodiments of the invention.

For clarity, identical reference numbers have been used, where applicable, to designate identical elements that are common between figures. It is contemplated that features of one embodiment may be incorporated in other embodiments without further recitation.

### DETAILED DESCRIPTION

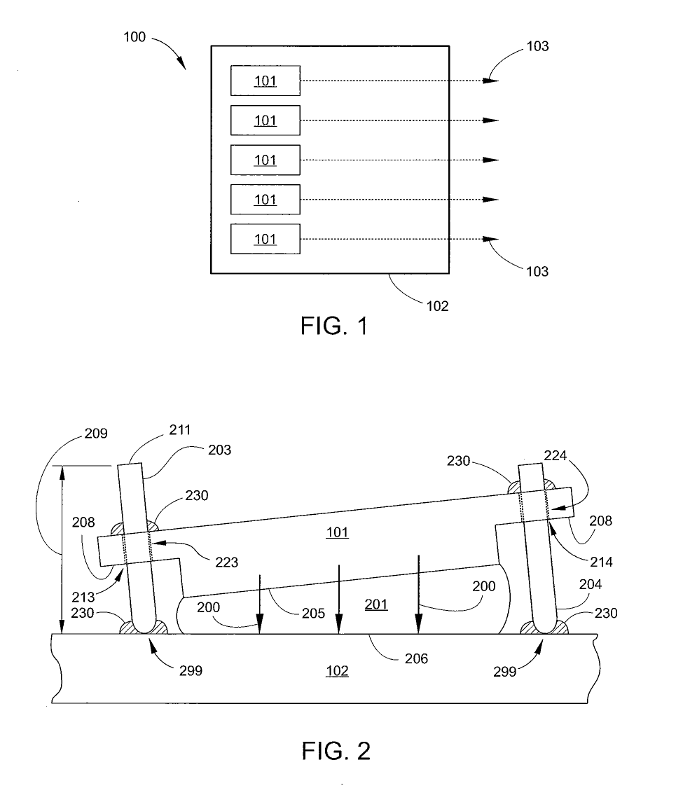

FIG. 1 is a schematic view of a laser diode array 100 that may benefit from embodiments of the invention. Laser diode array 100 may be part of a laser-phosphor display, a wavelength-division multiplexed (WDM) optical communication system, or any other device in which a plurality of lasers is used. Laser diode array 100 includes a plurality of laser diode assemblies 101 mounted on a baseplate 102. Each of laser diodes 101 produces a laser beam 103 that is precisely directed along a desired optical path in order for laser diode array 100 to operate properly. The optical path of each laser beam 103 is set as desired by positioning and then fixing in place each laser diode assembly 101 on baseplate 102 in a very precise fashion during the assembly of laser diode assembly 101. In this way, the optical path of each laser beam is directed as desired. Because the orientation of each laser diode assembly 101 is fixed with respect to baseplate 102 after assembly of laser diode array 100, substantial changes in temperature of a particular laser diode assembly 101 can, through thermal expansion or contraction of the laser diode assembly 101, alter the optical path of the associated laser beam 103. One skilled in the art will recognize that the performance of laser diode array 100 is degraded whenever such “drift” in the optical paths of laser beams 103 takes place, for example, when a precisely targeted region of a display is illuminated by laser diode array 100. Furthermore, excessive heating of the laser diode can significantly reduce its operating lifetime.

FIG. 2 is a schematic illustration of one laser diode assembly 101 of laser diode array 100 mounted on baseplate 102 and thermally coupled to baseplate 102 via a thermal conduction path 200, according to an embodiment of the invention. Thermal conduction path 200 is formed between the laser diode assembly 101 and baseplate 102. During operation, laser diode assembly 101 acts as a heat-generating device, and baseplate 102 acts as a stable platform and heat sink for laser diode assembly 101. Baseplate 102 comprises a thermally conductive material, such as stainless steel, aluminum, and the like, and is relatively massive in comparison to laser diode assembly 101. Thermal conduction path 200 includes a heat-conducting material 201 and contacts a significant portion of a surface 205 of laser diode assembly 101, thereby facilitating the conduction of thermal energy from laser diode assembly 101 to baseplate 102 at a heat transfer rate that prevents laser diode assembly 101 from exceeding a maximum operating temperature. The maximum operating temperature for laser diode assembly 101 is defined as the temperature above which laser diode assembly 101 experiences enough thermal expansion to significantly affect the optical path of laser beam 103 or the performance or operating lifetime of the laser diode itself.

Heat-conducting material 201 is disposed between laser diode assembly 101 and baseplate 102 as shown and is comprised of a metallic, low-melting point material, such as an indium-containing alloy. Heat-conducting material 201 is selected to have a melting-point temperature that is less than the critical temperature of laser diode assembly 101, i.e., less than the temperature at which laser diode assembly 101 and/or materials or components included in laser diode assembly 101 may be damaged or the working life of said components may be reduced. For example, in some embodiments, the critical temperature is the temperature at which thermal break-down occurs in a laser diode in laser diode assembly 101, plastic deformation of a component associated with laser diode assembly 101, or the alignment of an optical component associated with laser diode assembly 101 is substantially altered. For example, exposure of a laser diode to high temperatures can damage the crystal structure, leading to a premature decline in performance of the diode due to non-radiative recombination. The critical temperature for a laser diode in laser diode assembly 101, optics, precision plastics, and other temperature-sensitive components can be as low as 80 or 90° C. In some embodiments, the specific composition of heat-conducting material 201 is selected such that the melting-point temperature of heat-conducting material 201 is substantially less than 80° C. In embodiments in which heat-conducting material 201 is an alloy of two or more elements, heat-conducting material 201 is selected such that the liquidus of the alloy is substantially less than 80° C.

In some embodiments, heat-conducting material 201 is an indium-containing alloy having a suitable liquidus of substantially less than the critical temperature of diode assembly 101. For example, in one embodiment, heat-conducting material 201 comprises an indium-bismuth alloy having a liquidus of approximately 72° C., a composition of 66.3% indium and 33.7% bismuth, and a thermal conductivity of at least 0.10 W/cm-° C. In other embodiments, heat-conducting material 201 may comprise an alloy that does not contain indium, but still has a liquidus or melting point substantially less than the critical temperature of a diode assembly 101 or other heat-generating component that may benefit from thermal conduction path 200 to baseplate 102.

In addition to the thermal coupling of laser diode assembly 101 to baseplate 102, laser diode assembly 101 is also mechanically coupled to baseplate 102. In the embodiment illustrated in FIG. 2, positioning members 203, 204 facilitate the precise orientation and positioning of laser diode assembly 101 before laser diode assembly 101 is fixed in place on baseplate 102. In one embodiment, laser diode assembly 101 is positioned so that positioning members 203, 204 are disposed in through-holes 213, 214 formed in laser diode assembly 101, where positioning member 203 contacts a surface of through-hole 213 at contact point 223, and positioning member 204 contacts a surface of through-hole 214 at contact point 224. Contact point 223 and/or contact point 224 are adjusted until laser diode assembly 101 is precisely positioned as desired with respect to positioning members 203, 204 and baseplate 102, then laser diode assembly 101 is fixed in place on baseplate 102 and on positioning members 203, 204. In some embodiments, an adhesive material 230 is applied in or around through-holes 213, 214 and/or contact points 223, 224 in order to fix laser diode assembly 101 in the desired position.

In some embodiments, positioning members 203, 204 each include an end with a spherical radius 299 that contacts baseplate 102. Such a configuration ensures a point contact with baseplate 102 regardless of orientation and minimizes the air-gap which adhesive material 230 must fill. Having a small air gap filled by adhesive material 230 minimizes movement of laser diode assembly 101 that may occur due to shrinkage of adhesive material 230 as it cures.

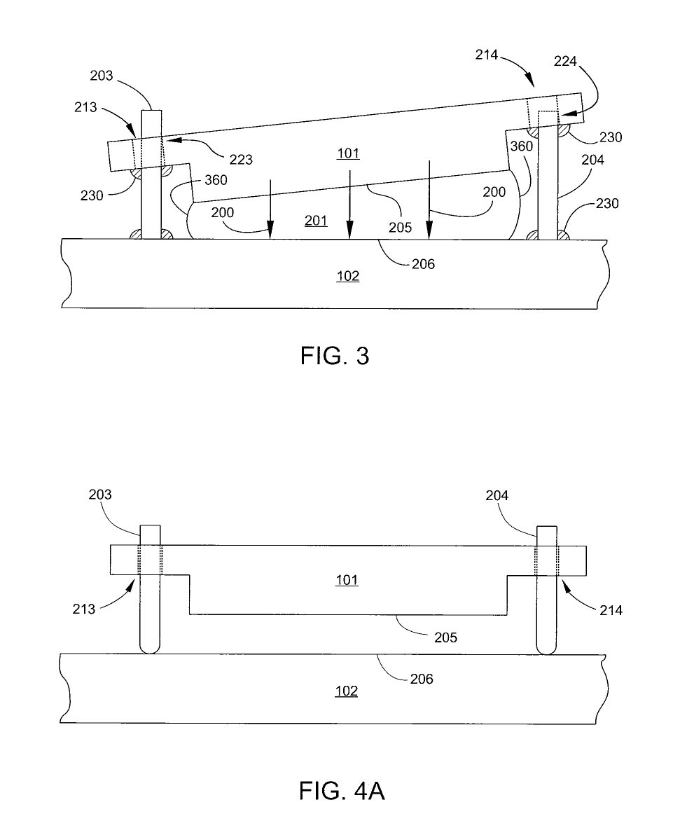

In the embodiment illustrated in FIG. 2, positioning members 203, 204 are dowel pins having a close fit to the inner diameter of through-holes 213, 214, respectively, and are fixed in place on surface 206 of baseplate 102 with adhesive material 230 after laser diode assembly 101 is precisely positioned. In other embodiments, positioning members 203, 204, are fixed to baseplate 102 prior to precisely positioning laser diode assembly 101. In one such embodiment, laser diode assembly 101 is positioned by placing surfaces 208 of laser diode assembly 101 in contact with the top surfaces 211 of positioning members 203, 204 and adjusting the height 209 of each of positioning members 203, 204 as desired. In such an embodiment, positioning members 203, 204 are configured with an adjustable height with respect to surface 206 of baseplate 102. For example, positioning members 203, 204 may be threaded through baseplate 102, and height 209 can be adjusted by rotation of positioning members 203, 204. In another such embodiment, the outer diameter of positioning members 203, 204 have a loose fit with the inner diameter of through-holes 213, 214, respectively, and are fixed in place on contact points 223, 224 with adhesive material 230 after laser diode assembly 101 is precisely positioned. FIG. 3 illustrates an embodiment of the invention in which positioning members 203, 204 are fixed to baseplate 102 prior to positioning laser diode assembly 101. Other configurations of positioning members 203, 204 also fall within the scope of the invention.

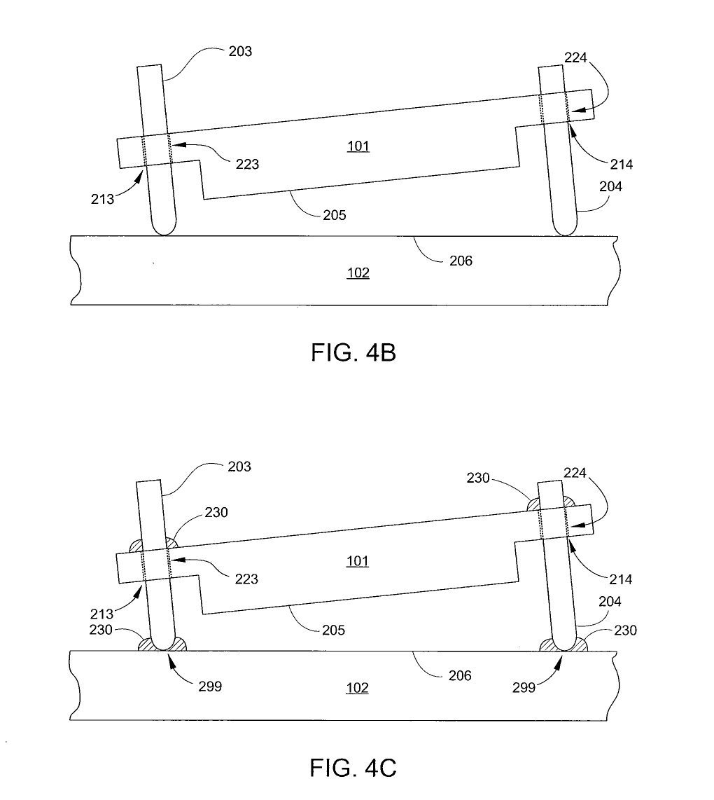

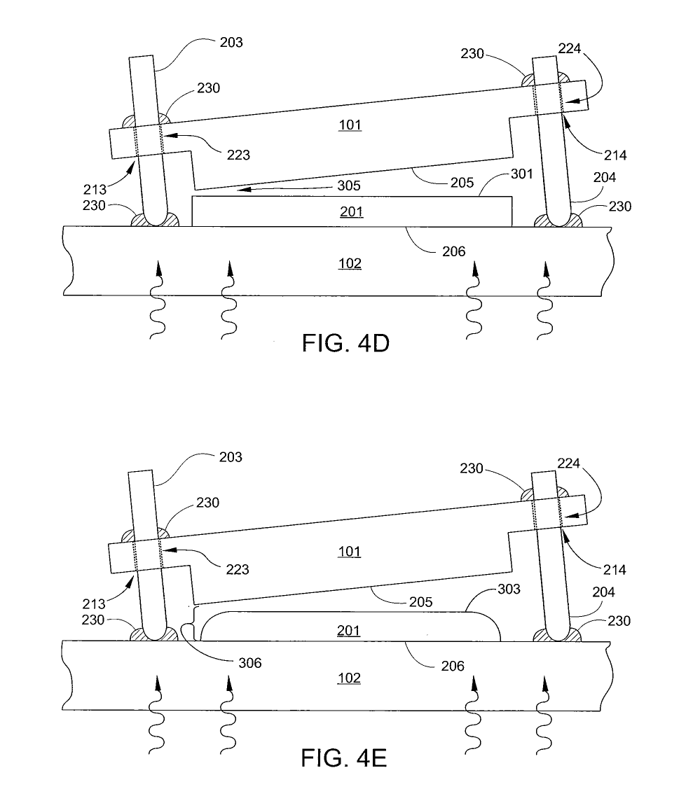

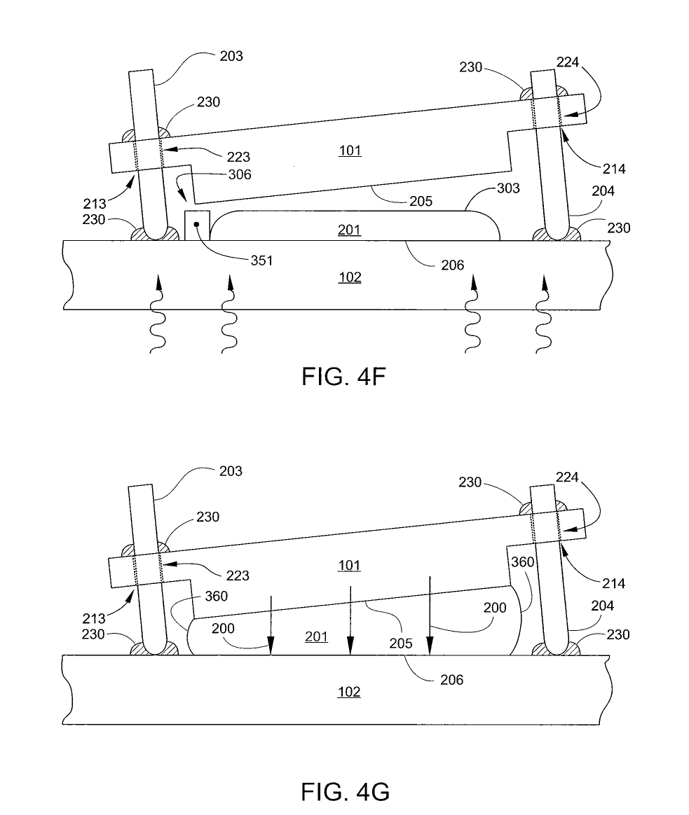

FIGS. 4A-G illustrate schematic side views of thermal conduction path 200 being formed between laser diode 101 and baseplate 102, in accordance with one embodiment of the invention.

FIG. 4A illustrates laser diode assembly 101 positioned positioning members 203, 204 disposed in through-holes 213, 214 formed in laser diode assembly 101. Prior to the formation of thermal conduction path 200, laser diode assembly 101 is to be precisely positioned with respect to baseplate 102. In some embodiments, positioning members 203, 204 are permanently fixed to baseplate 102. In the embodiment illustrated in FIG. 4A, positioning members 203, 204 are dowel pins that are not fixed to baseplate 102 prior to positioning laser diode assembly 101 and have a close fit to the inner diameter of through-holes 213, 214.

For illustrative purposes, only two positioning members 203, 204 are shown in FIG. 4A, however, three, four, or more positioning members may be mechanically coupled to baseplate 102 to facilitate the precise positioning and orientation of laser diode assembly 101 as desired. For example, in an embodiment in which baseplate 102 has three positioning members coupled thereto, laser diode assembly 101 can be fixedly attached at three contact points, which together define a plane. Thus, by adjusting the location of the three contact points on the three positioning members, the position of laser diode assembly 101 can be adjusted to any desired orientation with respect to baseplate 102 and stably fixed in place. Configurations of other numbers of positioning members also fall within the scope of the invention.

In some embodiments, prior to the formation of thermal conduction path 200, surface 205 of laser diode assembly 101 and/or surface 206 of baseplate 102 are treated to be substantially oxide-free surfaces. In one embodiment, surfaces 205 and/or 206 are plated with a material that forms little or no native oxide when exposed to air, such as an electroless nickel plating. In another embodiment, surfaces 205 and/or 206 may comprise a material that oxidizes relatively quickly, such as aluminum or an aluminum alloy, but undergoes an oxide-removal process before the formation of thermal conduction path 200. Suitable oxide-removal processes include mechanical/abrasive removal techniques, chemical removal techniques, and the like. In some embodiments, the oxide removal process is performed immediately prior to the formation of thermal conduction path 200 in order to minimize re-oxidation of surface 205.

FIG. 4B illustrates baseplate 102 and laser diode assembly 101 after the position of laser diode assembly 101 with respect to baseplate 102 has been precisely adjusted as desired. Consequently, laser diode assembly 101 contacts contact point 223 with a surface of through-hole 213 and contact point 224 with a surface of through-hole 214, and surface 205 may not be parallel with surface 206 of baseplate 102. Any technically feasible laser-alignment technology known in the art may be implemented to adjust the position of laser diode assembly 101. In some embodiments, a fixture or other external apparatus is used to hold laser diode assembly 101 in position prior to being fixed in place in the desired orientation. As shown, laser diode assembly 101 is not placed in contact with baseplate 102.

FIG. 4C illustrates baseplate 102 and laser diode assembly 101 after laser diode assembly 101 has been precisely fixed in place on positioning members 203, 204. In one embodiment, an adhesive material 230 is applied to positioning members 203, 204, in or around through-holes 213, 214, around spherical radii 299, and/or on contact points 223, 224 in order to fix laser diode assembly 101 in the desired position. In the embodiment illustrated in FIG. 4C, adhesive material 230 is applied at the openings of through-holes 213, 214 and around spherical radii 299 after positioning members 203, 204 have been inserted therein and the position of laser diode assembly 101 has been precisely established. After application and hardening of adhesive material 230, laser diode assembly 101 is fixed in place with respect to baseplate 102. In alternative embodiments, through-holes 213, 214 are filled with adhesive material 230 or internal surfaces of through-holes 213, 214 are coated with a layer of adhesive material 230 prior to the insertion of positioning members 203, 204. Adhesive material 230 may be selected based on adhesion to the materials making up positioning members 203, 204 and through-holes 213, 214. It is noted that the use of adhesive material 230 is only one embodiment of the invention, and the use of any other technically feasible, low-temperature technique to fix laser diode assembly 101 to positioning members 203, 204 falls within the scope of the invention.

FIG. 4D illustrates baseplate 102 and laser diode assembly 101 after a mass 301 of heat-conducting material 201 has been positioned between baseplate 102 and laser diode assembly 101. As shown, a gap 305 between mass 301 and surface 205 of laser diode assembly 101 may be present after mass 301 is positioned on baseplate 102 to prevent misalignment of laser diode assembly 101. Heat-conducting material 201 is selected to have a relatively high thermal conductivity, e.g., at least about 0.10 W/cm-° C., and a melting-point temperature or liquidus that is less than a critical temperature of laser diode assembly 101, e.g., less than about 80° C. In some embodiments, mass 301 comprises a preform, such as a flat plate having a plan-view outline, or “footprint,” that is substantially similar to the plan-view outline of surface 205. In such embodiments, the configuration of mass 301 as a preform facilitates the formation of thermal conduction path 200 having maximum thermal contact between laser diode 101 and baseplate 102. Thermal conduction path 200 is shown in FIG. 4G.

After mass 301 has been positioned between baseplate 102 and laser diode assembly 101 as shown in FIG. 4D, mass 301 is heated to the melting-point temperature or liquidus of heat-conducting material 201. In one embodiment, mass 301 is heated indirectly by heating baseplate 102 to the melting-point temperature or liquidus of heat-conducting material 201. In such an embodiment, the maximum temperature reached by heat-conducting material 201 can be closely controlled, thereby preventing over-heating of laser diode assembly 101 when heat-conducting material 201 is being heated to a liquid state. In alternative embodiments, mass 301 is heated directly via any technically feasible heating technology known in the art. It is noted that heating mass 301 in such alternative embodiments is more likely to over-heat laser diode assembly 101 than indirectly heating mass 301 via baseplate 102.

FIG. 4E illustrates baseplate 102 and laser diode assembly 101 after mass 301 has reached a liquid state, forming pool 303 of liquid-phase heat-conducting material 201. Generally, pool 303 does not contact surface 205 until more heat-conducting material 201 is added to pool 303. It is noted that in embodiments in which mass 301 comprises a preform alloy plate having a footprint that matches that of surface 205, pool 303 will also have a footprint that matches that of surface 205. In such embodiments, the presence of pool 303 proximate the opening 306 between surface 205 and baseplate 102 facilitates the subsequent addition of heat-conducting material 201, since the capillary action of pool 303 can draw in any additional heat-conducting material 201 positioned near opening 306.

FIG. 4F illustrates baseplate 102, laser diode assembly 101, and pool 303 as more additional heat-conducting material 351 is added to pool 303. In some embodiments, additional heat-conducting material may be added in liquid-phase. In the embodiment illustrated in FIG. 4F, additional heat-conducting material 351 is added to pool 303 by positioning solid-phase heat-conducting material 201 in or near pool 303 on baseplate 201, so that over-heating of laser diode assembly 101 is avoided. Specifically, because the temperature of the solid-phase additional heat-conducting material 351 is below the melting-point temperature or liquidus of heat-conducting material 201, the temperature of additional heat-conducting material 351 is also below the critical temperature of laser diode assembly 101. Thus, additional heat-conducting material 351, when solid-phase, cannot over-heat laser diode assembly 101. In contrast, in order to add liquid-phase heat-conducting material 201 to pool 303, the liquid-phase material being added to pool 303 is generally heated above the melting-point temperature or liquidus to prevent crystallization during the addition process, thereby potentially over-heating laser diode assembly 101. Any technically feasible approach known in the art for adding solid-phase heat-conducting material 201 to pool 303 may be implemented. For example, pellets or rectangular strips of heat-conducting material 201 may be positioned at or near the edge of surface 205 and opening 306 so that the capillary action of pool 303 can draw in additional heat-conducting material 351 once converted to liquid-phase. Additional heat-conducting material 351 is added to pool 303 until a desired portion of surface 205 is in contact with heat-conducting material 201. Generally, it is desirable for all of surface 205 to be in thermal contact with heat-conducting material 201. Once sufficient heat-conducting material 201 is present between baseplate 102 and laser diode assembly 101, baseplate 102 is no longer heated and no further heat-conducting material is added to pool 303.

FIG. 4G illustrates baseplate 102 and laser diode assembly 101 with thermal conduction path 200 formed therebetween. As shown, additional heat-conducting material 351 has been added to pool 303 (shown in FIG. 4F) until most or all of surface 205 is in thermal contact with heat-conducting material 201, thereby forming a robust thermal path to baseplate 102. In the embodiment illustrated in FIG. 4G, thermally-conductive path 200 includes a convex meniscus 360 between surface 205 and baseplate 102. Because the geometry of meniscus 360 is determined by the properties of heat-conducting material 201, surface 205, and surface 206 of baseplate 102, in other embodiments meniscus 360 may be convex. Once meniscus 360 has formed around surface 205, most or all of surface is in thermal contact with heat-conducting material 201 and heat-conducting material 201 is allowed to cool and solidify in place. Consequently, thermally-conductive path 200 is physically attached to baseplate 102 and surface 205 of laser diode assembly 101.

Thus, as shown in FIG. 4G, thermally-conductive path 200 provides thermal contact between a heat-generating device, i.e., laser diode assembly 101, and a heat sink, i.e., baseplate 102, without over-heating or degrading the alignment of the heat-generating device. While embodiments disclosed herein are described in terms of a laser diode assembly disposed on a baseplate, one of skill in the art will appreciate that any heat-generating device that relies on precise orientation with respect to a baseplate for proper operation may benefit from embodiments of the invention.

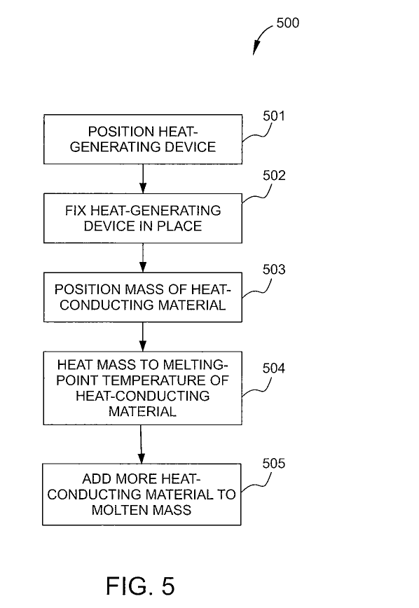

FIG. 5 sets forth a flowchart of method steps for forming a thermal conduction path, according to embodiments of the invention. Although the method steps are described with respect to thermal conduction path 200 of FIG. 2, persons skilled in the art will understand that performing the method steps, in any order, to form any other thermal conduction path is within the scope of the invention. Prior to the start of the method 500, an oxide-removal process may be performed on some or all of surface 205 of laser diode assembly 101 and surface 206 of baseplate 102.

As shown, method 500 begins at step 501, where a heat-generating device, i.e., laser diode assembly 101, is placed in a desired orientation with respect to a supporting surface, such as baseplate 102, as illustrated in FIG. 4B. In some embodiments, laser diode assembly 101 is positioned in the desired orientation by adjusting one or more contact points with positioning members 203, 204 disposed on baseplate 102.

In step 502, laser diode assembly 101 is fixed in place at the desired orientation, as illustrated in FIG. 4C. In some alternative embodiments, positioning members 203, 204 used to facilitate orientation of laser diode assembly 101 in step 501 may be also be fixedly attached to baseplate 102 in step 502.

In step 503, a solid-phase mass 301 of heat-conducting material 201 is positioned between laser diode assembly 101 and baseplate 102. In a preferred embodiment, mass 301 comprises a preform configured to match the footprint of laser diode assembly 101.

In step 504, after positioning mass 301 between laser diode assembly 101 and baseplate 102, mass 301 is heated to the melting-point temperature of heat-conducting material 201 to form pool 303 of liquid-phase heat-conducting material 201 between laser diode assembly 101 and baseplate 102.

In step 505, after heating mass 301, additional heat-conducting material 351 is added to pool 303 until meniscus 360 is formed between laser diode assembly 101 and baseplate 102, so that surface 205 is in thermal contact with baseplate 102.

In sum, embodiments of the invention set forth a thermal conduction path for a heat-sensitive component and a method of forming the same. One advantage of the present invention includes a highly conductive thermal path for a temperature-sensitive device that can be formed without altering the alignment, positioning, and orientation of the device. In addition, embodiments of the present invention advantageously provide a method for forming such a conductive thermal path that will not damage the temperature-sensitive device.

While the foregoing is directed to embodiments of the present invention, other and further embodiments of the invention may be devised without departing from the basic scope thereof, and the scope thereof is determined by the claims that follow.

We claim:

1. A method for generating a thermally conductive path between a first surface and a supporting surface that are separated by a gap, the method comprising:
positioning a solid-phase mass of thermally-conductive material within the gap between the first surface and the supporting surface such that the solid-phase mass rests on either the supporting surface or the first surface but does not simultaneously rest on both the supporting surface and the first surface;
heating the solid-phase mass to a melting-point temperature to produce a liquid-phase thermally conductive material within the gap; and
continuing to heat the liquid-phase thermally conductive material until a meniscus is formed between the first surface and the supporting surface.

2. The method of claim 1, wherein the melting point temperature is below a critical temperature associated with the first surface and a critical temperature associated with the supporting surface.

3. The method of claim 1, wherein the critical temperature associated with the first surface comprises a temperature at which thermal break-down of a laser diode associated with the first surface occurs, plastic deformation of a component associated with the first surface occurs, or the alignment of an optical component associated with the first surface is substantially altered.

4. The method of claim 1, wherein the first surface comprises a surface of a thermal-collecting device.

5. The method of claim 4, wherein the thermal-collecting device comprises a heat-generating device.

6. The method of claim 5, further comprising, prior to the step of positioning, placing the heat-generating device in a desired orientation relative to the supporting surface to form the gap between the first surface and the supporting surface.

7. The method of claim 5, wherein placing the heat-generating device in a desired orientation comprises adjusting a contact point between the heat-generating device and at least one positioning member that contacts the supporting surface.

8. The method of claim 5, wherein the heat-generating device comprises a laser diode and placing the heat-generating device in the desired orientation comprises orienting an output of the laser diode along a desired optical path.

9. The method of claim 1, wherein heating the solid-phase mass to the melting-point temperature comprises heating the supporting surface to the melting-point temperature.

10. The method of claim 1, further comprising adding additional thermally conductive material to the liquid-phase thermally conductive material within the gap to form the meniscus between the first surface and the supporting surface.

11. The method of claim 10, wherein adding additional thermally conductive material to the liquid-phase thermally conductive material comprises adding solid-phase thermally conductive material to the liquid-phase thermally conductive material.

12. An apparatus comprising:
a supporting surface;
at least one positioning member that contacts a heat-generating device and the supporting surface; and
a thermally conductive path disposed between the supporting surface and the heat-generating device and comprising a metallic thermally-conductive material having a melting-point temperature that is less than a critical temperature of the heat-generating device.

13. The apparatus of claim 12, wherein the positioning member is coupled to the supporting surface with an adhesive.

14. The apparatus of claim 12, wherein the critical temperature of the heat-generating device comprises a temperature at which thermal break-down of a laser diode associated with the heat-generating device occurs, plastic deformation of a component associated with the heat-generating device occurs, or the alignment of an optical component associated with the heat-generating device is substantially altered.

15. The apparatus of claim 12, wherein the heat-generating device comprises a laser diode.

16. The apparatus of claim 12, wherein the thermally-conductive material has a thermal conductivity of at least 0.10 W/cm-° C.

17. The apparatus of claim 12, wherein the thermally-conductive material has a melting point or liquidus that is substantially less than 80° C.

18. The apparatus of claim 12, wherein the thermally-conductive material comprises an indium-containing alloy.

19. The apparatus of claim 12, wherein the at least one positioning member is affixed to at least one of the heat-generating device and the supporting surface.

20. A laser-diode assembly comprising:
a supporting surface;
a plurality of laser diodes, wherein at least one laser diode is affixed to a positioning member that is coupled to the supporting surface; and
a thermally conductive path disposed between the supporting surface and the at least one laser diode and comprising a metallic thermally-conductive material having a melting-point temperature that is less than a critical temperature of the laser diode.

21. The laser-diode assembly of claim 20, wherein the thermally-conductive material comprises an indium-containing alloy.

22. The laser-diode assembly of claim 20, wherein the thermally-conductive material has a thermal conductivity of at least 0.10 W/cm-° C.
